(19) United States
(12) Patent Application Publication
(10) Pub. No.: US 2009/0141609 A1
(43) Pub. Date: Jun. 4, 2009

(54) MULTI-LAYERED OPTICAL RECORDING MEDIUM AND METHOD FOR OPTICAL RECORDING AND READING

(76) Inventors: Koji MISHIMA, Tokyo (JP); Takashi KIKUKAWA, Tokyo (JP); Hiroyasu INOUE, Tokyo (JP); Hajime UTSUNOMIYA, Tokyo (JP)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 12/276,581

(22) Filed: Nov. 24, 2008

(30) Foreign Application Priority Data
Nov. 29, 2007 (JP) 2007-308133

(51) Int. Cl. G11B 7/00

(52) U.S. Cl. 369/94; G9B/7

(57) ABSTRACT

A multi-layered optical recording medium is provided of which the manufacturing costs is significantly reduced. The multi-layered optical recording medium has multiple information recording layers and at least two layers of the information recording layers have the same medium-side address information. This configuration allows for reducing the types of master stampers and thus reducing manufacturing costs.

### BACKGROUND OF THE INVENTION

1. Field of the Invention

The present invention relates to a multi-layered optical recording medium with multiple information recording layers and to a recording and reading method for irradiating the multi-layered optical recording medium with laser light for recording and reading.

2. Description of the Related Art

Conventionally, for digital moving image contents to be viewed and digital data to be recorded, optical recording media have been widely used which include CD-DAs, CD-ROMs, CD-Rs, CD-RWs, DVD-ROMs, DVD-Rs, DVD+/−RWs, and DVD-RAMS. Meanwhile, the recording capacity required of these types of optical recording media has been increasing year by year. To meet this demand, so-called next-generation optical discs have been prepared for the market, which are capable of storing massive moving images and data. The next-generation optical disc provides an increased recording capacity by making as short as 405 nm the wavelength of the laser light used for recording and reading operations. For example, according to the Blu-ray Disc (BD) standard or one of the next-generation DVD standards, the numerical aperture of an objective lens is set to 0.85, thereby enabling recording and reading as much as 25 GB on one recording layer.

On the other hand, moving images and data are expected to increase in capacity more than ever before. This expectation has led to studies of methods for increasing the capacity of optical recording media by making a multi-layered information recording layer in the optical recording medium (Japanese Patent Application Laid-Open No. 2003-346379).

An information recording layer of an optical recording medium has a groove to which address information (hereinafter referred to as “medium-side address information”) is allocated in order to determine appropriate locations for recording and reading. To allocate the medium-side address information, a method is known in which the wobble frequency of the groove is modulated in order to provide a signal or the shape of a pit is changed in order to provide a signal. This medium-side address information is prepared in a stamper used for making the optical recording medium. The stamper transfers the medium-side address information to the substrate or to a spacer layer of the optical recording medium, thereby providing the medium-side address information to the optical recording medium.

In an optical recording medium, different addresses have to be allocated to all the areas of the information recording layer. Likewise, in a multi-layered optical recording medium, different medium-side addresses are thus allocated to all the information recording layers.

However, in order to provide different medium-side addresses to all the information recording layers of a multi-layered optical recording medium, it is necessary to prepare separate stampers, wherein each stamper corresponds to each information recording layer. For example, in order to manufacture a multi-layered optical recording medium having four layers, four types of stampers, each having different pieces of medium-side address information, have to be prepared in order to transfer an independent medium-side address to each information recording layer.

To make a stamper, an original master applied with a photoresist material is irradiated, while being rotated, with a laser beam in a step called “mastering” in order to write the medium-side address information onto the resist, and the resist is then exposed and developed. After that, manufacturing of the master stamper is then completed via a plating process and a step of removing the plating. Then, the master stamper is evaluated on a pass/fail basis through various inspection steps including those that assess the associated child stamper as well.

Accordingly, it would be tremendously costly to manufacture master stampers for all the information recording layers of a multi-layered optical recording medium.

Furthermore, any change in the original specification of the multi-layered optical recording medium would cause changes in the specification of all the information recording layers. This would necessitate all the stampers being remade, which may require a significant period of time, such as a few months, in order to meet the revised specification. In the manufacturing process for the multi-layered optical recording medium, all the stampers would have to be replaced, thereby lowering the availability of the manufacturing line.

Furthermore, in order to manufacture many such types of multi-layered optical recording media in volume, the stampers needing to be stocked would become enormous in type and number, thereby making stock control of the stampers themselves complicated.

### SUMMARY OF THE INVENTION

The present invention was developed in view of these problems. It is therefore an object of the present invention to provide a multi-layered optical recording medium which can be manufactured in volume at low costs and which can quickly respond to a change in specification. It is another object of the invention to provide a suitable method for optical recording and reading on this multi-layered optical recording medium.

With intensive studies made by the present inventors, the aforementioned objects are achieved by the means described below.

To achieve the aforementioned object, a first aspect of the present invention is a multi-layered optical recording medium having a plurality of information recording layers, wherein at least two layers of the information recording layers have same medium-side address information.

To achieve the aforementioned object, a second aspect of the present invention is a the multi-layered optical recording medium according to the foregoing aspect, wherein the at least two layers of the information recording layers having the same medium-side address information each are configured to have at least partially a determination area of mutually different optical reflection properties, to allow a layer position thereof to be identified.

To achieve the aforementioned object, a third aspect of the present invention is the multi-layered optical recording medium according to the foregoing aspects, wherein the at least two layers of the information recording layers having the same medium-side address information each are provided with an identification signal recorded to identify the layer position.

To achieve the aforementioned object, a fourth aspect of the present invention is the multi-layered optical recording medium according to the foregoing aspects, wherein the at least two layers of the information recording layers having the same medium-side address information are configured to have mutually different recording properties so that they can identify their layer positions from the recording properties.

To achieve the aforementioned object, a fifth aspect of the present invention is the multi-layered optical recording medium according to the foregoing aspects, wherein the at least two layers of the information recording layers having the same medium-side address information are configured to have mutually different optical reflectivity settings, to allow their layer positions to be identified.

To achieve the aforementioned object, a sixth aspect of the present invention is the multi-layered optical recording medium according to the foregoing aspects, wherein an information recording layer different in the medium-side address information from the at least two layers of the information recording layers is interposed between the at least two layers of the information recording layers having the same medium-side address information.

To achieve the aforementioned object, a seventh aspect of the present invention is the multi-layered optical recording medium according to the foregoing aspects, comprising a first information recording layer group including the information recording layers having in common first medium-side address information and a second information recording layer group including the information recording layers having in common second medium-side address information different from the first medium-side address information. The multi-layered optical recording medium is configured such that the information recording layers of the first information recording layer group and the information recording layers of the second information recording layer group are alternately stacked.

To achieve the aforementioned object, a eighth aspect of the present invention is a method for optical recording and reading, the method including irradiating a multi-layered optical recording medium with laser light, the multi-layered optical recording medium including at least two information recording layers having same medium-side address information, and identifying a layer position of the information recording layer from a difference in optical reflection property between the information recording layers.

To achieve the aforementioned object, a ninth aspect of the present invention is the method for optical recording and reading according to the foregoing aspect, including identifying the layer position of the information recording layer from a difference in stray light of reflected beams between the information recording layers when focused.

To achieve the aforementioned object, a tenth aspect of the present invention is the method for optical recording and reading according to the foregoing aspects, including identifying the layer position of the information recording layer from a difference in reflectivity between the information recording layers when focused.

To achieve the aforementioned object, a eleventh aspect of the present invention is a method for optical recording and reading, the method including irradiating a multi-layered optical recording medium with laser light, the multi-layered optical recording medium including at least two information recording layers having same medium-side address information, and identifying a layer position of the information recording layer based on how many times the information recording layers are traversed by the laser light in the direction of the stacked layers while the laser light is focused thereon.

To achieve the aforementioned object, a twelfth aspect of the present invention is a method for optical recording and reading, the method including irradiating a multi-layered optical recording medium with laser light, the multi-layered optical recording medium including at least two information recording layers having same medium-side address information, and identifying a layer position of the information recording layer by reading an identification signal recorded on the information recording layer.

To achieve the aforementioned object, a thirteenth aspect of the present invention is a method for optical recording and reading on a multi-layered optical recording medium including at least two information recording layers having same medium-side address information, the method including focusing the information recording layers of the multi-layered optical recording medium and identifying a layer position of the information recording layer from an amount of correction for spherical aberration.

To achieve the aforementioned object, a fourteenth aspect of the present invention is a method for optical recording and reading on a multi-layered optical recording medium including, between at least two information recording layers having same medium-side address information, an information recording layer different in spiral direction from the two information recording layers, the method including irradiating the multi-layered optical recording medium with laser light, detecting a spiral direction of the information recording layer from a tracking control value for an optical pickup, and thereby identifying a layer position of the information recording layer.

To achieve the aforementioned object, a fifteenth aspect of the present invention is a method for optical recording and reading on a multi-layered optical recording medium including at least two information recording layers having same medium-side address information, the method including irradiating the multi-layered optical recording medium with laser light, and identifying a layer position of the information recording layer based on an information recording condition for the information recording layer.

To achieve the aforementioned object, a sixteenth aspect of the present invention is a method for optical recording and reading on a multi-layered optical recording medium including at least two information recording layers having same medium-side address information, the method being configured such that when irradiating the multi-layered optical recording medium with laser light to record information thereon, a medium-side address at which a recording signal is written is made different from an information-side address which the recording signal has.

The optical recording medium of the present invention includes multiple information recording layers which have the same medium-side address information. Accordingly, the shared use of a master stamper makes it possible to reduce the types of master stampers required and therefore cut manufacturing costs. Note that the shared use of a master stamper will also facilitate the reduction in the number of inspection step required for each stamper which is made using this master stamper. For example, a mother stamper made using the master stamper and a child stamper made using the mother stamper can also be provided at reduced costs. Furthermore, use of the same medium-side address information facilitates the management of medium-side address information for the entire multi-layered optical recording medium, so that a mother stamper and a child stamper, which have the same medium-side address information, can be combined appropriately for manufacturing.

### BRIEF DESCRIPTION OF THE DRAWINGS

The above and other objects, features and advantages of the present invention will become apparent from the following description and appended claims, taken in conjunction with the accompanying drawings.

FIG. 1 is a block diagram illustrating the system configuration of an optical recording and reading system according to a first embodiment of the present invention;

FIGS. 2A and 2B show a perspective view and an enlarged sectional view, respectively, illustrating a multi-layered optical recording medium to be read by the optical recording and reading system;

FIG. 3 is an enlarged sectional view illustrating further magnified information recording layers of the multi-layered optical recording medium;

FIG. 4 is an explanatory view illustrating a method for manufacturing the multi-layered optical recording medium and the specification of master stampers used for manufacturing;

FIG. 5 is a flowchart showing a method for optical recording and reading by the optical recording and reading system;

FIG. 6 is a flowchart showing a method for optical recording and reading by an optical recording and reading system according to a second embodiment of the present invention;

FIG. 7 is a view illustrating stray light patterns used in a method for optical recording and reading according to a third embodiment of the present invention;

FIG. 8 is a flowchart showing a method for optical recording and reading by an optical recording and reading system according to a fourth embodiment of the present invention;

FIG. 9 is a graph illustrating an example S-shaped curve of a focus error signal used in the method for optical recording and reading;

FIG. 10 is a tabular view illustrating by way of example the amount of correction for spherical aberration used in a method for optical recording and reading according to a fifth embodiment of the present invention;

FIG. 11 is a flowchart showing the method for optical recording and reading; and

FIG. 12 is an explanatory view illustrating a method for manufacturing a multi-layered optical recording medium according to a sixth embodiment of the present invention and the specification of master stampers used for manufacturing.

### DETAILED DESCRIPTION OF THE PREFERRED EMBODIMENTS

Now, the present invention will be described below in more detail with reference to the accompanying drawings in accordance with embodiments.

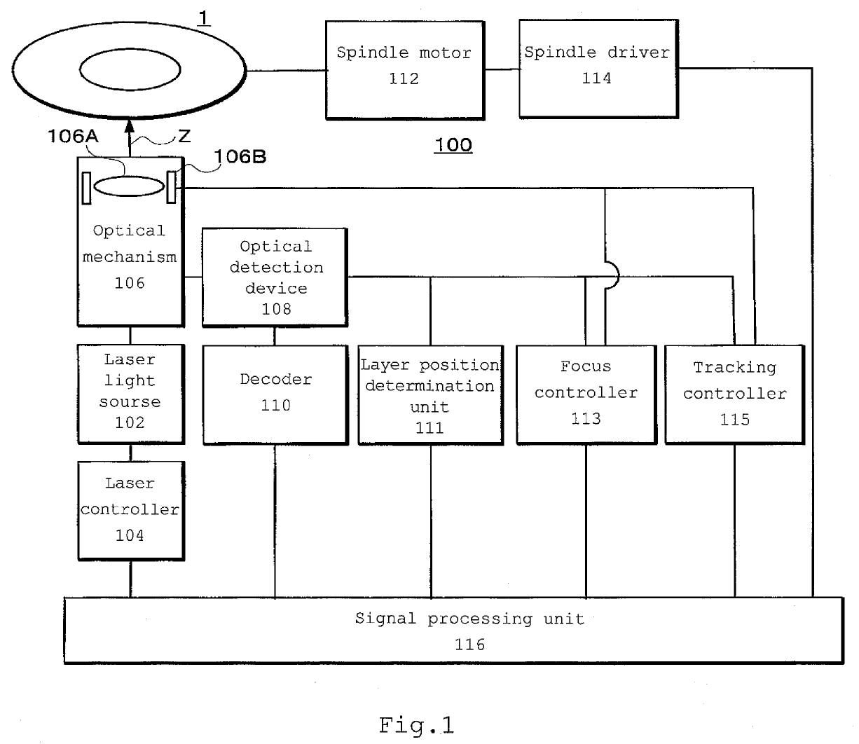

FIG. 1 illustrates a multi-layered optical recording medium 1 according to a first embodiment of the present invention, and the configuration of an optical recording and reading system 100 for recording and reading information on the multi-layered optical recording medium 1. The optical recording and reading system 100 includes a laser light source 102; a laser controller 104; an optical mechanism 106; an optical detection device 108; a decoder 110; a layer position determination unit 111; a spindle motor 112; and a spindle driver 114; a focus controller 113, a tracking controller 115, and a signal processing unit 116. The laser light source 102 generates laser light Z used for reading. The laser controller 104 controls the laser light source 102. The optical mechanism 106 directs the laser light Z to the multi-layered optical recording medium 1. The optical detection device 108 detects reflected light of the laser light Z. The decoder 110 decodes detection information from the optical detection device 108. The spindle motor 112 rotates the multi-layered optical recording medium 1. The spindle driver 114 controls the rotation of the spindle motor 112. The focus controller 113 detects a focus error (FE) based on an electrical signal sent from the optical detection device 108, and then uses this focus error signal to controllably drive a lens driving coil 106B in the direction of focus (along an optical axis). The tracking controller 115 detects a tracking error based on an electrical signal sent from the optical detection device 108, and then uses this tracking error to controllably drive the lens driving coil 106B in the direction of tracking. The signal processing unit 116 exchanges decoded read data with a CPU (Central Processing Unit) (not shown).

The laser light source 102, which is a semiconductor laser, is controlled by the laser controller 104 to generate the laser light Z with a predetermined power in a prescribed waveform. The optical mechanism 106 includes an objective lens 106A and a polarizing beam splitter, and is capable of focusing the laser light Z on an information recording layer as appropriate. Furthermore, the optical mechanism 106 also includes an expander lens for changing the amount of correction for spherical aberration at each information recording layer. Note that the polarizing beam splitter extracts the reflected light from the information recording layer to direct it to the optical detection device 108.

The optical detection device 108 is a photodetector for receiving reflected light of the laser light Z to convert it into an electrical signal, which is in turn delivered as a read signal to the PRML (Partial Response Maximum Likelihood) processing unit 110. The PRML processing unit 110 decodes this read signal and then outputs a decoded binary identification signal to the signal processing unit 116.

The layer position determination unit 111 determines, for example, based on information from the optical detection device 108, the position of an information recording layer on which a recording or reading operation is being performed, and then outputs the results to the information processing unit 116.

Furthermore, the optical recording and reading system 100 employs the laser light Z whose wavelength λ is set at 400 to 410 nm. Furthermore, the optical mechanism 106 employs the objective lens 106A whose numerical aperture NA is set at 0.84 to 0.86. More specifically, the laser light Z has a wavelength λ set at 405 nm, and the objective lens 106A has a numerical aperture NA set at 0.85. Furthermore, the optical reading block has a clock frequency f set at 66 MHz. The rpm of the multi-layered optical recording medium 1 which is rotatably controlled by the spindle driver 114 can be controlled freely within the range of 0 to 10000 rpm.

To initiate an information reading operation on the multi-layered optical recording medium 1, the laser light Z is generated with a predetermined reading power from the laser light source 102, and then an information recording layer of the multi-layered optical recording medium 1 is irradiated with the laser light Z to start the reading operation. The laser light Z is reflected on the information recording layer, and then acquired via the optical mechanism 106 to be turned into an actual read signal at the optical detection device 108.

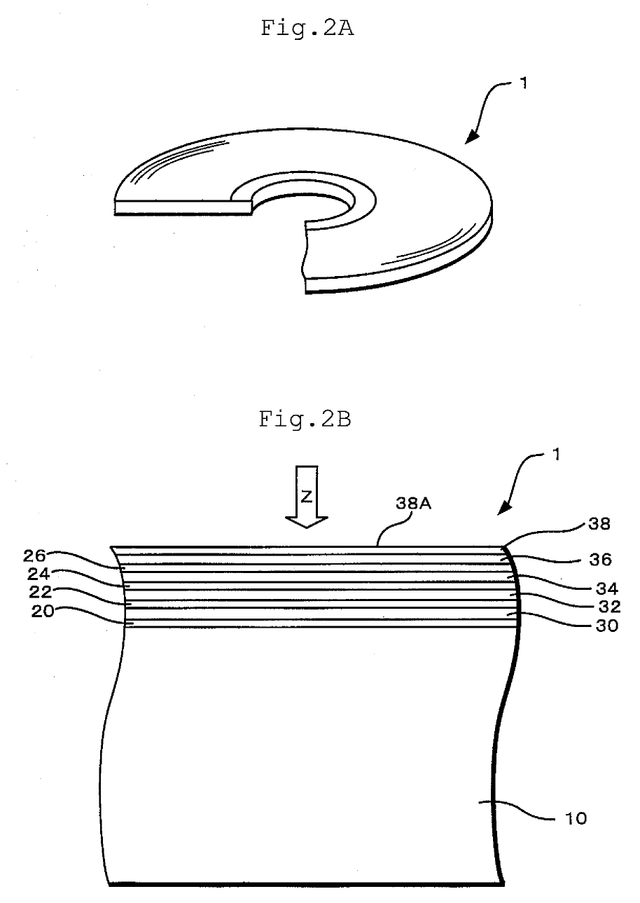

FIG. 2A illustrates the overall configuration of a multi-layered optical recording medium 1. The multi-layered optical recording medium 1 is a disc-like medium with an outer diameter of approximately 120 mm and a thickness of approximately 1.2 mm. As shown in a magnified view in FIG. 2B, the multi-layered optical recording medium 1 includes a substrate 10, an L0 information recording layer 20, an L1 spacer layer 30, an L1 information recording layer 22, an L2 spacer layer 32, an L2 information recording layer 24, an L3 spacer layer 34, an L3 information recording layer 26, a cover layer 36, and a hard coat layer 38, which are stacked in this order. Accordingly, the multi-layered optical recording medium 1 has a layer structure of four information recording layers.

These L0 to L3 information recording layers 20, 22, 24, and 26 are the layers responsible for storing data. The modes of data storage include a read-only type which where data is previously written without permitting rewriting of the data and a recording type which allows the user to write data. The recording type is employed here. The recording type for storing data is further divided into a write-once type and a rewritable type. The write-once type allows data to be written onto an area only once and thus allows no additional data to be written onto the same area. The rewritable type allows data written on an area to be erased and additional data to be rewritten onto the same area. In the present embodiment, the write-once type is taken by way of example. Note that the L0 to L3 information recording layers 20, 22, 24, and 26 can take mutually different types for storing data.

The L1 to L3 spacer layers 30, 32, and 34, the cover layer 36, and the hard coat layer 38 are all light-transmitting, thus allowing externally incident laser light to pass therethrough. Consequently, use of the laser light Z incident upon a light incident surface 38A of the hard coat layer 38 enables recording and reading of information on the L0 to L3 information recording layers 20, 22, 24, and 26. Note that the L3 information recording layer 26 is the information recording layer lying closest to the light incident surface 38A of the multi-layered optical recording medium 1, whereas the L0 information recording layer 20 is the information recording layer farthest from the light incident surface 38A. In the present embodiment, such an example is shown in which each of the information recording layers 20 and 22 has a recording capacity of 25 GB. Note that each information recording layer can have respective different recording capacities as well as any recording capacities other than 25 GB.

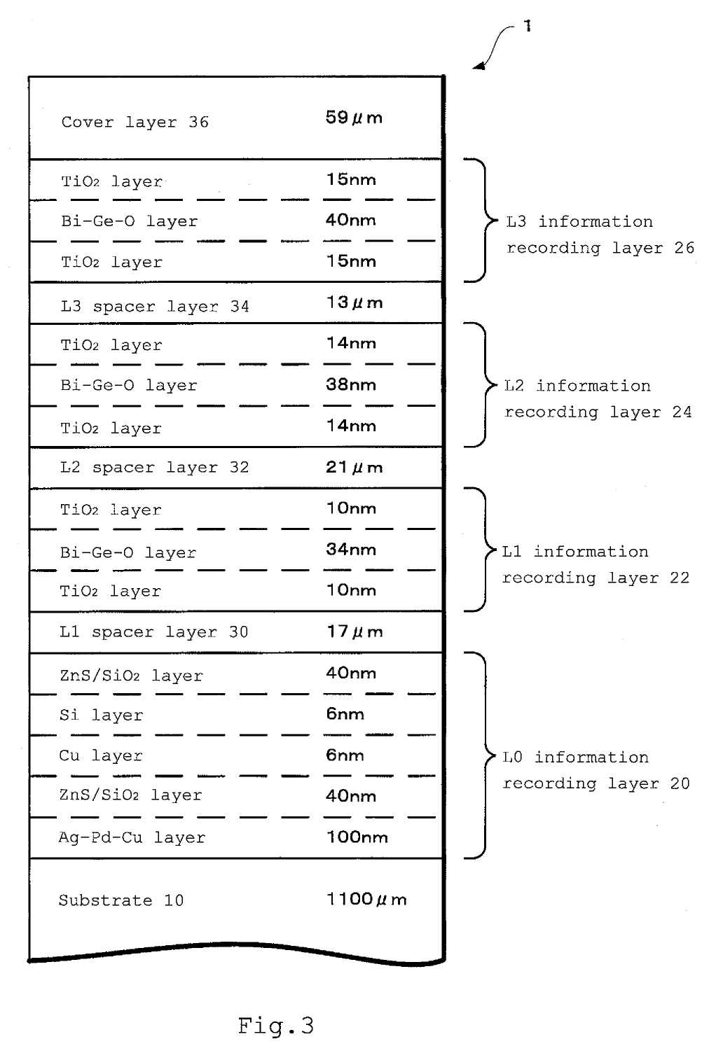

As is also shown in a magnified view in FIG. 3, the substrate 10 is a disc-like member having a thickness of approximately 1100 μm, and can be formed of various raw materials such as glass, ceramics, and resin. The present embodiment employs a polycarbonate resin. Note that other resins than the polycarbonate resin can also be employed, for example, olefin resins, acrylic resins, epoxy resins, polystyrene resins, polyethylene resins, polypropylene resins, silicone resins, fluororesins, ABS resins, and urethane resins. Of these, polycarbonate resins and olefin resins are preferable from the viewpoint of ease of processing and molding. Furthermore, the surface of the substrate 10, facing the information recording layers, is provided with grooves, lands, pit rows or the like depending on its application.

In the order from the substrate, the L 0 information recording layer 20 is made up of a Ag/Pd/Cu layer (Ag:Pd:Cu mole ratio=98:1:1) with a thickness of 100 nm, a ZnS/SiO₂ layer (ZnS:SiO₂ mole ratio=80:20) with a thickness of 40 nm, a Cu layer with a thickness of 6 nm, a Si layer with a thickness of 6 nm, and a ZnS/SiO₂ layer with a thickness of 40 nm. Here, the Cu layer and the Si layer serve as an inorganic active film to provide different optical reflectivities by being melted and mixed when heated with the laser light Z.

The L1 spacer layer 30 is stacked between the L0 information recording layer 20 and the L1 information recording layer 22, and serves to separate them from each other. The L1 spacer layer 30 is provided, on its surface facing the light incident surface 38A, with grooves (lands), pit rows, and the like. The groove is designed to store the medium-side address information. As mentioned above, the spacer layer 30 can be formed of various materials, but it is necessary to use a light-transmitting material to permit the laser light Z to pass therethrough. For example, UV curable acrylic resins may be preferably employed. Note that the L1 spacer layer 30 is set to have a thickness of 17 μm.

In the order from the substrate, the L1 information recording layer 22 is made up of a TiO₂ layer with a thickness of 10 nm, a Bi/Ge/O layer (Bi:Ge:O mole ratio=28:2:70) with a thickness of 34 nm, and a TiO₂ layer with a thickness of 10 nm.

The L2 spacer layer 32 is stacked between the L1 information recording layer 22 and the L2 information recording layer 24, and serves to separate them from each other. The L2 spacer layer 32 is provided, on its surface facing the light incident surface 38A, with grooves (lands), pit rows, and the like. Note that the L2 spacer layer 32 is set to have a thickness of 21 μm.

In the order from the substrate, the L2 information recording layer 24 is made up of a TiO₂ layer with a thickness of 14 nm, a Bi/Ge/O layer (Bi:Ge:O mole ratio=25:7:68) with a thickness of 38 nm, and a TiO₂ layer with a thickness of 14 nm.

The L3 spacer layer 34 is stacked between the L2 information recording layer 24 and the L3 information recording layer 26, and serves to separate them from each other. The L3 spacer layer 34 is provided, on its surface facing the light incident surface 38A, with grooves (lands), pit rows, and the like. Note that the L3 spacer layer 34 is set to have a thickness of 13 μm.

In the order from the substrate, the L3 information recording layer 26 is made up of a TiO₂ layer with a thickness of 15 nm, a Bi/Ge/0 layer (Bi:Ge:O mole ratio=22:10:68) with a thickness of 40 nm, and a TiO₂ layer with a thickness of 15 nm.

The cover layer 36 including the hard coat layer 38 is set to have a thickness of 50 μm. Consequently, in the multi-layered optical recording medium 1, the L0 information recording layer 20 is stacked at a position of 110 μm from the light incident surface 38A, while the other L1 to L3 information recording layers 22, 24, and 26 are stacked within 110 μm from the light incident surface 38A.

The groove formed on each of the substrate 10 and the L1 to L3 spacer layers 30, 32, and 34 serves as a guide track for the laser light Z when recording data. The energy intensity of the laser light Z traveling along the groove is modulated, thereby forming record marks on each of the information recording layers 20, 22, 24, and 26 on the groove. The groove also serves to identify the medium-side address and acquire the medium-side address of a particular individual location from the tracking signal.

Furthermore, a disc information area can be provided with the disc information signal of each information recording layer by a wobble encoded signal or the like formed on the groove. For example, this disc information signal includes the number of information recording layers, and the recording conditions, the recording strategy, the amount of correction for spherical aberration of each information recording layer, and the like. The disc information area is also provided with a recording area on which information on the layer position of an information recording layer is recorded when the layer position of the information recording layer is determined.

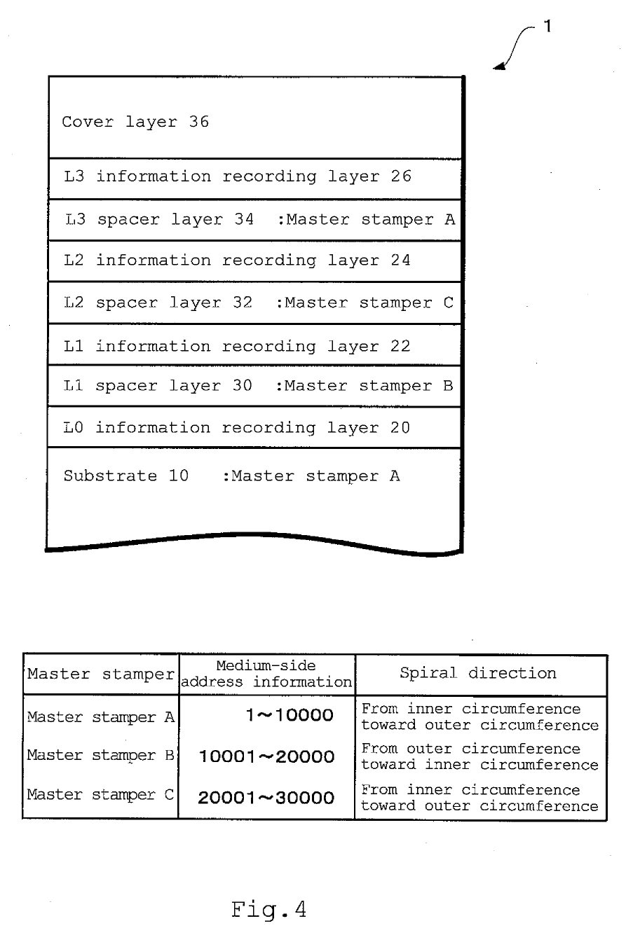

As shown in FIG. 4, the multi-layered optical recording medium 1 is provided with a medium-side address which is formed using each stamper prepared with a master stamper A, a master stamper B, or a master stamper C. The master stamper A provides as the medium-side address information, for example, an allocation range of 1 to 10000 with the spiral of the groove directed from inside toward outside. The master stamper B provides as the medium-side address information, for example, an allocation range of 10001 to 20000 with the spiral of the groove directed from outside to inside. The master stamper C provides as the medium-side address information, for example, an allocation range of 20001 to 30000 with the spiral of the groove directed from inside toward outside. Note that as used herein, the term “medium-side address information” is determined by both the allocation range of address and the spiral direction. Accordingly, “the consistency of medium-side address information” refers to the consistency in terms of both the allocation range of address and the spiral direction, thus leading to such a relation as allowing a master stamper to be shared. On the other hand, “the inconsistency of (or difference in) medium-side address information” refers to the inconsistency in terms of at least one of the allocation range of address and the spiral direction, thus leading to such a relation as allowing no master stamper to be shared.

Note that in the present embodiment, a stamper for actually transferring a groove to the substrate 10 is a mother stamper made of metal which is prepared using a master stamper. On the other hand, a stamper for transferring a groove to each of the spacer layers 30, 32, and 34 is a stamper made of a transparent resin which is formed using a child stamper prepared with a master stamper.

The substrate 10 is manufactured using a stamper prepared with the master stamper A. Consequently, the L0 information recording layer 20 is provided as the medium-side address information with an allocation range of 1 to 10000, with the spiral direction being set from inside toward outside. The L1 spacer layer 30 is manufactured using a stamper prepared with the master stamper B. Consequently, the L1 information recording layer 22 is provided as the medium-side address information with an allocation range of 10001 to 20000, with the spiral direction being set from outside to inside. The L2 spacer layer 32 is manufactured using a stamper prepared with the master stamper C. Consequently, the L2 information recording layer 24 is provided as the medium-side address information with an allocation range of 20001 to 30000, with the spiral direction being set from inside toward outside. The L3 spacer layer 34 is manufactured using a stamper prepared with the same master stamper A as for the substrate 10. Consequently, the L3 information recording layer 26 is provided as the medium-side address information with an allocation range of 1 to 10000, with the spiral direction being set from inside toward outside.

Accordingly, the two layers of the L0 to L3 information recording layers 20, 22, 24, and 26 in the multi-layered optical recording medium 1, i.e., the L0 information recording layer 20 and the L3 information recording layer 26 have the same medium-side address information. Furthermore, between the L0 information recording layer 20 and the L3 information recording layer 26 which are formed using the common master stamper A, the L1 and L2 information recording layers 22 and 24 are interposed which are formed using the master stampers B and C that provide different pieces of medium-side address information.

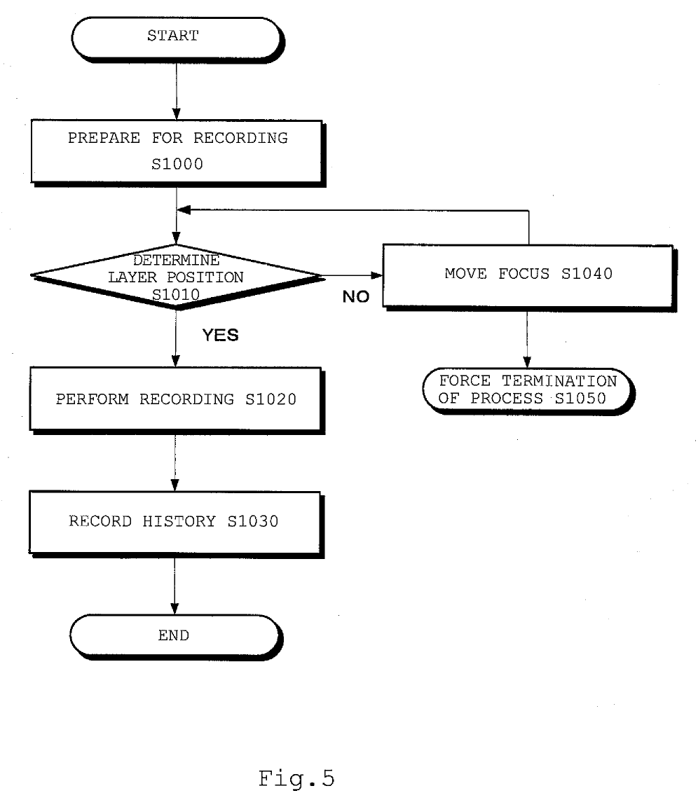

Now, with reference to the flowchart of FIG. 5, a description will be made to a method for recording information onto and reading information from the multi-layered optical recording medium 1 using the optical recording and reading system 100.

For example, such a case will be considered in which information is recorded at a medium-side address 900 in the L3 information recording layer 26. First, in Step 1000, preparations are made for the recording. More specifically, the multi-layered optical recording medium 1 is rotated at a predetermined linear velocity by means of the spindle motor 112. Then, the focus of the laser light Z is moved to the medium-side address 900 of the L3 information recording layer 26 by the focus controller 113 and the tracking controller 115.

Subsequently in Step 1010, the layer position determination unit 111 determines which information recording layer of the L0 to L3 information recording layers 20, 22, 24, and 26 is being currently focused. Here, the determination is specifically made based on the tracking signal, the spiral direction that can be found from the direction of travel of the pickup, and the medium-side address information obtained from the information processing unit 116. It is thus determined whether the laser light Z has been focused on the L3 information recording layer 26. More specifically, if the spiral is directed from the outer circumference toward the inner circumference or the medium-side address is out of the range of 1 to 10000, then the determination is made to output an error because the current layer is not the L3 information recording layer 26. Note that the spiral direction can be acquired from the control value given by the tracking controller 115. Furthermore, the medium-side address information can be acquired from the signal processing unit 116.

Note that the position of each information recording layer in the multi-layered optical recording medium 1 can be estimated even by the optical recording and reading system 100 based on its standards or specifications. In principle, based on the standards or specifications, the L3 information recording layer 26 would be accurately focused. However, an increase in the number of layers of the multi-layered optical recording medium 1 as seen in the present embodiment causes the distances between the layers to be reduced. This may presumably cause a focus error to occur, such that another adjacent information recording layer (here, the L2 information recording layer 24) may be focused. Accordingly, the layer position determination unit 111 makes use of the difference in the spiral direction or the medium-side address information to determine the layer position of the information recording layer being focused. It is thus avoided to write information onto a wrong location.

If it is determined in Step 1010 that the correct information recording layer has been focused, the process proceeds to Step 1020 to write the actual information at the medium-side address 900 of the L3 information recording layer 26. In this case, the information-side address information is not to be the same with the medium-side address 900. After the recording has been completed, the process proceeds to Step 1030, where the recording history is written onto the disc information area provided on the innermost circumference or the outermost circumference of the L3 information recording layer 26. Then, the recording operation is ended. On the other hand, if it is determined in Step 1010 that the correct information recording layer has not been focused, the process proceeds to Step 1040, where the focus is moved in the correct direction. Then, the process goes back to Step 1010, where the layer position of the information recording layer being focused is determined again. If the error cannot be corrected even after Step 1040 and Step 1010 have been repeated a certain number of times, then the process proceeds to Step 1050 to be forcefully terminated.

In the first embodiment, according to the multi-layered optical recording medium 1 and the method for optical recording and reading, the multi-layered optical recording medium 1 has a four-layer structure, but nevertheless can be manufactured using the three types of master stampers A, B, and C. To this end, the medium-side address information of the L0 information recording layer 20 is made same with that of the L3 information recording layer 26. Consequently, it is possible to reduce manufacturing costs. Furthermore, the number of types of master stampers is reduced. It is thus possible to facilitate the management of the stampers and reduce the possibility of human errors such as use of wrong stampers in manufacturing.

Furthermore, in the multi-layered optical recording medium 1, the two layers, i.e., the information recording layers 22 and 24 having different pieces of medium-side address information are interposed between the L0 information recording layer 20 and the L3 information recording layer 26, which have the same medium-side address. Consequently, the distance between the L0 information recording layer 20 and the L3 information recording layer 26 is increased, thereby making it possible to reduce the possibility of confusing between both the layers during recording or reading. In particular, in the first embodiment, for precautionary purposes before recording (reading) operations, the layer position determination unit 111 checks the difference in the medium-side address information based on the spiral direction or the allocation range of address. For this reason, when an information recording layer adjacent to the target information recording layer is erroneously focused, the erroneous focusing can be detected and corrected in advance.

Furthermore, in the first embodiment, when information is recorded, the information-side address information carried by the information side is configured not to be the same with the medium-side address information. In particular, it is preferable that the information-side address information of the information to be recorded on the L0 information recording layer 20 is made different from that of the L3 information recording layer 26, so that each information recording layer can be distinguished based on the information-side address. During reading of a once-recorded signal, this allows for pre-checking the information-side address information, thereby preventing erroneous information from being read.

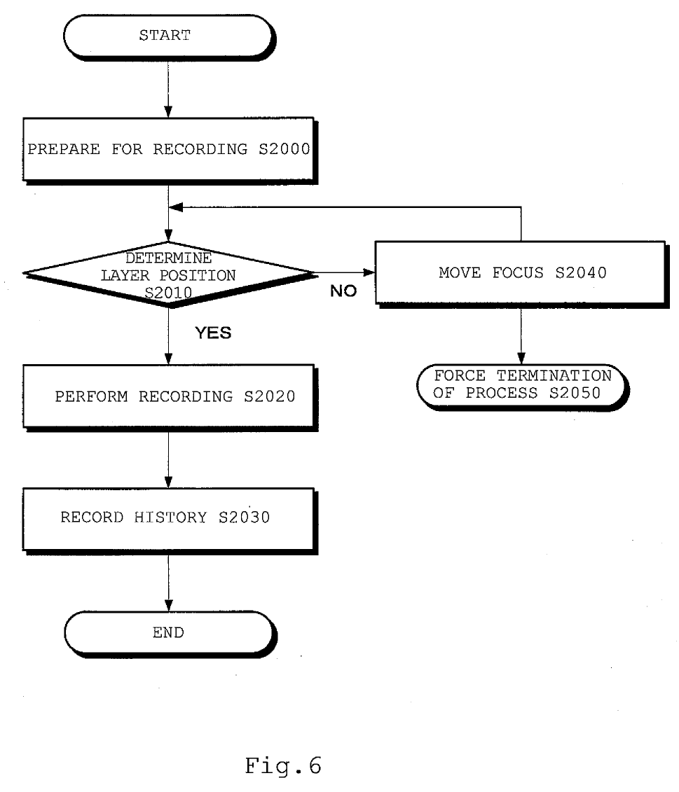

Now, with reference to the flowchart of FIG. 6, a description will be made to a method for optical recording and reading on the multi-layered optical recording medium according to a second embodiment. Note that the multi-layered optical recording medium and the optical recording and reading system employed in the method for optical recording and reading are the same as those of the first embodiment. The optical recording and reading system 100 is used as it is for the explanation, and thus no description will be made to the components and structure thereof. Furthermore, a multi-layered optical recording medium 201 of the second embodiment includes L0 to L3 information recording layers 220, 222, 224, and 226, which have mutually different settings of optical reflectivities. Except these settings, the basic structure is the same as that of the multi-layered optical recording medium 1 of the first embodiment. Thus, the same components will be given the reference numbers of the same lowest and second lowest digits, and not illustrated or described in detail.

Suppose that information is recorded onto the location at the medium-side address 900 of the L3 information recording layer 226 in the multi-layered optical recording medium 201. In this case, preparations are first made for the recording in Step 2000. More specifically, the spindle motor 112 rotates the multi-layered optical recording medium 201 at a predetermined linear velocity, and the focus controller 113 and the tracking controller 115 move the focus of the laser light Z to the medium-side address 900 of the L3 information recording layer 226. Subsequently in Step 2010, the layer position determination unit 111 determines which information recording layer of the L0 to L3 information recording layer 220, 222, 224, and 226 is being currently focused. Here, specifically, the optical reflectivity information which has been recorded on a BCA (Burst Cutting Area) or the disc information area is read in advance from each information recording layer. Furthermore, the actual output level from the optical detection device 108 is used to calculate the optical reflectivity of the information recording layer being currently focused. This optical reflectivity is compared with the optical reflectivity information carried on the multi-layered optical recording medium 201 to determine that the information recording layer having the closest reflectivity information is the information recording layer being currently focused.

If it has been determined in Step 2010 that the correct information recording layer is being focused, the process proceeds to Step 2020 to write the actual information at the medium-side address 900 of the L3 information recording layer 226. After the recording has been completed, the process proceeds to Step 2030, where the recording history is written onto the disc information area provided on the innermost circumference or the outermost circumference of the L3 information recording layer 226. Then, the recording operation is ended. On the other hand, if it is determined in Step 2010 that the correct information recording layer has not been focused, the process proceeds to Step 2040 to move the focus to another information recording layer. Then, back in Step 2010, the layer position of the information recording layer being focused is determined again based on the optical reflectivity. If the error cannot be corrected even after Step 2040 and Step 2010 have been repeated a certain number of times, the process proceeds to Step 2050 to be forcefully terminated.

According to the second embodiment, even if a plurality of information recording layers have the same medium-side address information in the multi-layered optical recording medium 201, the information recording layer being currently focused can be identified based on the difference in optical reflectivity. Accordingly, while the number of master stampers is reduced to thereby cut the manufacturing costs of the multi-layered optical recording medium 201, it is possible to avoid recording and reading errors which may be caused by the information recording layer being erroneously identified. Note that the second embodiment provides an advantage that the information recording layers 220, 222, 224, and 226 have mutually different optical reflectivities in all the areas, and thus any of the information recording layers can be identified regardless of the location. However, the present invention is not limited to this. For example, a dedicated determination area may be provided at part of each of the information recording layers 220, 222, 224, and 226 to determine the layer position, and only the reflectivities at the determination areas may be varied for each layer. This allows for eliminating the need for making the optical reflectivities of each of the information recording layers 220, 222, 224, and 226 themselves different from each other, thereby providing enhanced design flexibility and further reducing the manufacturing costs. Furthermore, it is also preferable to have an identification signal recorded on the determination areas to determine the layer position, without changing the optical reflectivity at the determination areas. Note that this identification signal is not limited only to a barcode pattern like BCA or an encoded signal used for a typical data recording signal, so long as the identification signal is unique to each information recording layer. For example, the determination can also be made even when the frequency or the degree of modulation of the signal is varied for each information recording layer. Alternatively, by eliminating the need for recording an identification signal onto all the information recording layers, the availability of a record to those information recording layers having the same medium address information may be employed to determine the layer position.

The determination area is prepared in this manner at part or all of the information recording layers 220, 222, 224, and 226. Before recording and reading information, this configuration allows the optical recording and reading system 100 to irradiate the determination area with the laser light Z, thereby identifying the layer position of the information recording layers from the difference in the optical reflection property. It is thus made possible for the plurality of information recording layers of the multi-layered optical recording medium 201 to have the same medium-side address information, thereby significantly reducing the manufacturing costs of the multi-layered optical recording medium 1. Note that as used herein, the term “optical reflection property” refers to not only the optical reflection property of each of the information recording layers 220, 222, 224, and 226 but also the optical reflection properties provided when reflected light or stray light from an adjacent information recording layer and the effects of spacer layers are all taken into consideration. What is essentially required is that the optical recording and reading system 100 can identify the information recording layer of the multi-layered optical recording medium 1 based on the difference in the property of the reflected light. Note that as used herein, the term “stray light” refers to the light reflected from an information recording layer other than the information recording layer on which reading or recording is to be performed.

Now, a description will be made to a method for optical recording and reading on a multi-layered optical recording medium according to a third embodiment. Note that except a method for determining an information recording layer in the multi-layered optical recording medium, the multi-layered optical recording medium and the optical recording and reading system employed in this method for optical recording and reading are almost the same as those of the first embodiment. Therefore, using the multi-layered optical recording medium 1 and the optical recording and reading system 100 as they are, the description will be thus made only to the different points without any more detailed explanation to the components and structure.

In the third embodiment, the optical detection device 108 in the optical recording and reading system 100 is replaced with a CCD device which has multiple photodetectors arranged in a matrix. It is therefore possible to detect a wide range of reflected light from the L0 to L3 information recording layers 20, 22, 24, and 26. Furthermore, a signal detected at the center portion of the CCD device is delivered to the PRML processing unit 110, the focus controller 113, and the tracking controller 115 for typical control purposes. On the other hand, a wide range of image signals detected by the entire CCD device is delivered to the layer position determination unit 111 to be used to determine an information recording layer.

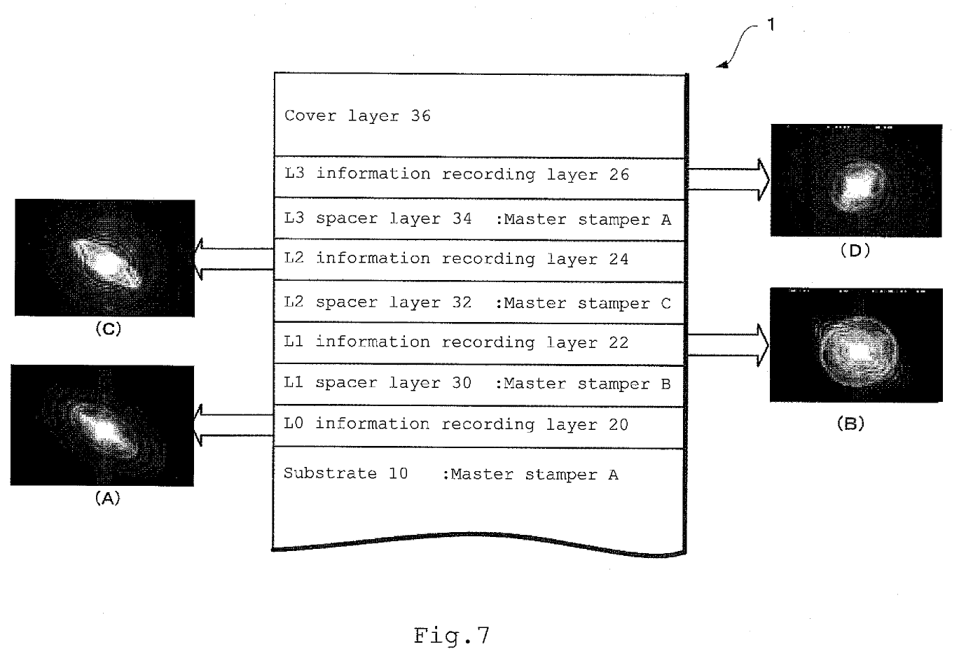

More specifically, as shown in FIG. 7, the image signal of reflected light detected by the optical detection device 108 turns into a stray light pattern which contains multiple elliptical beams or hyperbolic beams that are different in their magnitude and direction of deformation. The differences between stray light patterns result from the facts that the beams of the stray light component spread in different directions due to under-focusing or over-focusing, and the sizes of the elliptical beam and hyperbolic beam vary depending on the distance between the information recording layer to be read and the information recording layer that causes the stray light component. For example, as shown in FIG. 7A, the stray light pattern of the L0 information recording layer 20 is a collective pattern of multiple elliptical annular beams that spread from top left to bottom right in the figure. As shown in FIG. 7B, the stray light pattern of the L1 information recording layer 22 is formed by the overlap between a collection of multiple elliptical annular beams, which spread from top left to bottom right in the figure, and a collection of multiple perfect-circle annular beams. As shown in FIG. 7C, the stray light pattern of the L2 information recording layer 24 is formed by the overlap among the elliptical beams spreading from top left to bottom right in the figure, the perfect-circle blurred annular beams spreading outside the elliptical beams, and the hyperbolic beams that spread vertically and horizontally. As shown in FIG. 7D, the L3 information recording layer 26 has a collective pattern that contains elliptical beams that spread from top right to bottom left in the figure, perfect-circle annular beams formed on their outer circumference, and multiple elliptical annular beams that spread outside the annular beams from top left to bottom right in the figure. Since each of the information recording layers 20, 22, 24, and 26 has mutually different stray light patterns as described above, the layer position determination unit 111 can determine the layer position of an information recording layer from the stray light patterns. As such, the aforementioned stray light pattern is unique to each of the information recording layers. Accordingly, although an information recording layer can be identified through a determination made by detecting in detail the entirety of the stray light patterns, the invention is not limited thereto. When each information recording layer is read, it is also possible to place a photodetector at a position where the stray light pattern varies a great deal in the amount of light, thereby determining the layer position based on a change in the quantity of light detected on the photodetector.

According to the third embodiment, even if a plurality of information recording layers have the same medium-side address information in the multi-layered optical recording medium 1, the information recording layer being currently focused can be identified based on the difference in the stray light pattern using the reflected light. Accordingly, while the manufacturing costs of the multi-layered optical recording medium 1 are reduced, it is also possible to avoid recording and reading errors which may be caused by the information recording layer being erroneously identified.

A description will now be made to a method for optical recording and reading on a multi-layered optical recording medium according to a fourth embodiment. Note that except a method for determining an information recording layer in the multi-layered optical recording medium, the multi-layered optical recording medium and the optical recording and reading system employed in this method for optical recording and reading are almost the same as those of the first embodiment. Therefore, using the multi-layered optical recording medium 1 and the optical recording and reading system 100 as they are, the description will be thus made only to the different points without anymore detailed explanation to the components and structure.

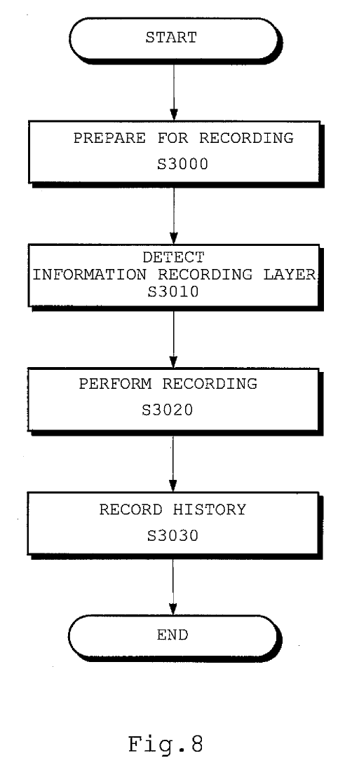

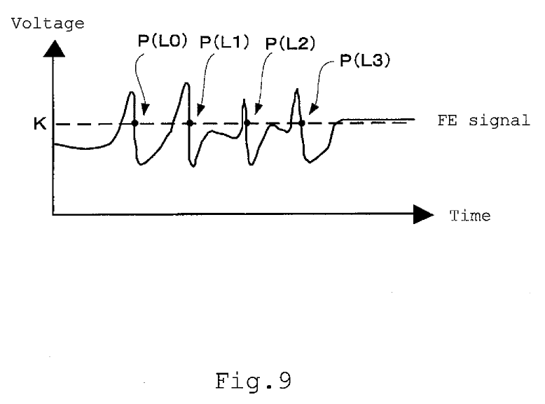

For example, suppose that information is recorded at the medium-side address 900 of the L3 information recording layer 26. In this case, as shown in the flowchart of FIG. 8, preparations are first made for the recording in Step 3000. More specifically, the spindle motor 112 rotates the multi-layered optical recording medium 1 at a predetermined linear velocity. Subsequently in Step 3010, the information recording layer is detected. More specifically, the focus controller 113 is used to move the beam spot of the laser light Z from the farthest position on the light incident surface 38A to the target information recording layer (in this case, the L3 information recording layer 26). For example, the focus controller 113 which has received a signal from the optical detection device 108 provides an S-shaped curve of a focus error (FE) signal as shown in FIG. 9. Those intersections P(L0), P(L1), P(L2), and P(L3) at which the S-shaped curve intersects a reference level K from the higher output voltage to the lower represent the timings at which the information recording layers 20, 22, 24, and 26 were traversed. Accordingly, the layer position determination unit 111 counts the number of the intersections to determine the layer position, and then stops the movement of the focus at the point in time the fourth count is encountered. Consequently, it is possible to positively focus the L3 information recording layer 26.

Subsequently in Step 3020, the tracking controller 115 is used to move the focus to the location of the medium-side address 900 in the L3 information recording layer 26, thereby allowing the actual information to be written at the medium-side address 900 of the L3 information recording layer 26. After the recording has been completed, the process proceeds to Step 3030 to write the recording history onto the disc information area provided on the innermost circumference or the outermost circumference of the L3 information recording layer 26. Then, the recording operation is ended.

In the fourth embodiment, it can be ensured that the position of all the information recording layers 20, 22, 24, and 26 is determined without depending on the medium-side address. Furthermore, since an identification signal for determining the layer position needs not to be recorded onto each of the information recording layers 20, 22, 24, and 26, it is possible to enhance the design flexibility of the multi-layered optical recording medium 1. Accordingly, the plurality of information recording layers in the multi-layered optical recording medium 1 can have the same medium-side address information, thereby reducing the manufacturing costs. Note that such a case has been shown here in which the layer position is determined based on the number of information recording layers that the focus has crossed over while moving from the L0 information recording layer 20. However, the layer position may also be determined based on the number of information recording layers that the focus has crossed over while moving from the light incident surface 38A.

A description will now be made to a method for optical recording and reading on a multi-layered optical recording medium according to a fifth embodiment. Note that except a method for determining an information recording layer in the multi-layered optical recording medium, the multi-layered optical recording medium and the optical recording and reading system employed in this method for optical recording and reading are almost the same as those of the first embodiment. Accordingly, using the multi-layered optical recording medium 1 and the optical recording and reading system 100 as they are, the description will be thus made only to the different points without anymore detailed explanation to the components and structure.

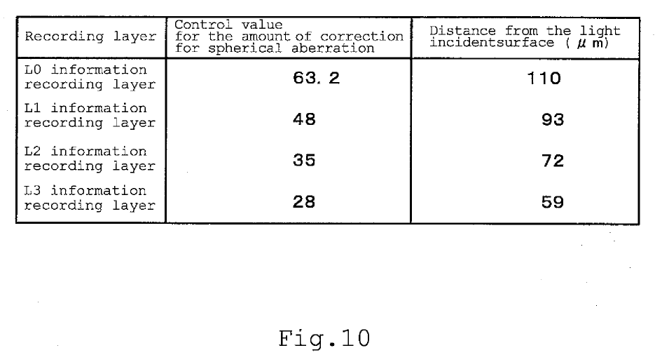

Each of the information recording layers 20, 22, 24, and 26 in the multi-layered optical recording medium 1 is located at a mutually different distance from the light incident surface 38A, and thus different magnitudes of spherical aberration. Accordingly, the optical recording and reading system 100 needs to use the focus controller 113 to make offset corrections to the optical mechanism 106, thereby focusing the laser spot on each of the information recording layers 20, 22, 24, and 26. As shown in FIG. 10, the amount of correction increases as the distance of the information recording layers 20, 22, 24, and 26 from the light incident surface 38A increases. The amount of correction is set in advance at the optical recording and reading system 100 or recorded on the disc information area or the like of the multi-layered optical recording medium 1.

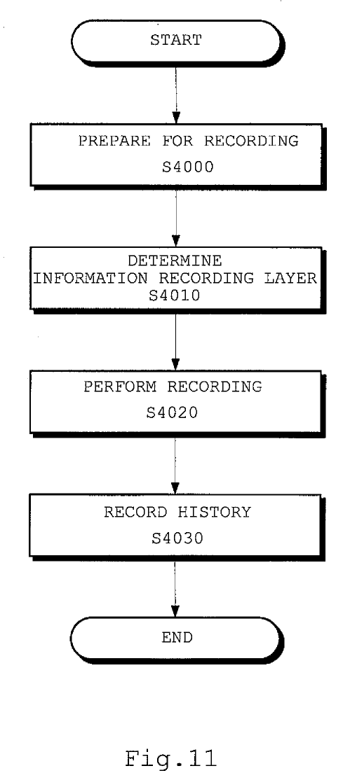

As shown in the flowchart of FIG. 11, to record information at the medium-side address 900 of the L3 information recording layer 26, preparations are first made for the recording in Step 4000. More specifically, the spindle motor 112 rotates the multi-layered optical recording medium 1 at a predetermined linear velocity. Then, the focus controller 113 and the tracking controller 115 are used to move the focus of the laser light Z to the medium-side address 900 of the L3 information recording layer 26. At this time, an appropriate amount of correction to correct for spherical aberration is set, thereby allowing the focus to be achieved. More specifically, the focus is achieved using the amount of correction for spherical aberration estimated by the focus controller 113. Then, when a predetermined magnitude of the amplitude of a tracking error signal has not yet been reached without tracking, an adjustment is made to the amount of correction for correcting spherical aberration. This operation is repeated, so that the amount of correction for spherical aberration is repeatedly adjusted until the predetermined magnitude of the amplitude of the tracking error signal is reached.

Subsequently in Step 4010, the layer position determination unit 111 determines (checks) which information recording layer of the L0 to L3 the information recording layers 20, 22, 24, and 26 is being currently focused, from the amount of correction for spherical aberration. That is, suppose that with the tracking error having reached the predetermined magnitude of the amplitude, the control value of the amount of correction for spherical aberration provided by the focus controller 113 is 28 by way of example. In this case, from the determination table of FIG. 10, it can be determined that the L3 information recording layer 26 is currently being focused.

If it is confirmed in Step 4010 that the correct information recording layer has been focused, then the process proceeds to Step 4020 to write the actual information at the medium-side address 900 of the L3 information recording layer 26. After the recording has been completed, the process proceeds to Step 4030 to write the recording history onto the disc information area provided on the innermost circumference or the outermost circumference of the L3 information recording layer 26. Then, the recording operation is ended. Note that when the focus is achieved, the amplitude of the tracking error signal can be used to control the amount of correction for spherical aberration. This is because with each information recording layer having an inconsistent amount of correction for spherical aberration, the beam spot may spread on the information recording layer, thus causing the tracking error signal not to be detected (observed). However, the method for adjusting the amount of correction for spherical aberration is not limited to the one above, and another method may also be employed for the adjustment. For example, a SUM signal or a recorded read signal can also be used to correct for spherical aberration. In the case of the SUM signal, adjustments can be made using the property that the amount of light will increase by optimizing the amount of correction for spherical aberration. In the case of using the recorded read signal, adjustments can be made using the property that reading properties such as jitter or error are improved by optimizing the amount of correction for spherical aberration.

According to the fifth embodiment, even if the plurality of information recording layers of the multi-layered optical recording medium 1 have the same medium-side address information, the layer position of the information recording layer can be checked ex post facto from the amount of correction for spherical aberration that is one of the control signals provided by the optical recording and reading system 100. Note that such a case has been shown here in which use is made of the amount of correction for spherical aberration. However, the present invention is not limited thereto. Any control signal for the optical pickup can be used, so long as it is dependent on the layer position of the information recording layer, as the information for checking ex post facto the layer position of the information recording layer.

Furthermore, in the fifth embodiment, such a case has been shown in which the layer position of the information recording layer is identified based on the focus control value for the optical pickup. In addition to this, it is also possible to identify the layer position of the information recording layer based on the recording condition employed for recording information onto the information recording layer. For example, suppose that a plurality of information recording layers have the same medium-side address information, so that the optimal recording power for one information recording layer is different from the optimal recording power of another information recording layer. In this case, it is possible to determine the layer position based on the difference between the recording power conditions. Likewise, when the optimal recording strategy for one information recording layer is different from the optimal recording strategy for another information recording layer, it is possible to determine the layer position based on the difference between the recording strategies. In this case, it is necessary to determine the material and the thickness of the plurality of information recording layers having the same medium-side address so that the layers have mutually different recording properties.

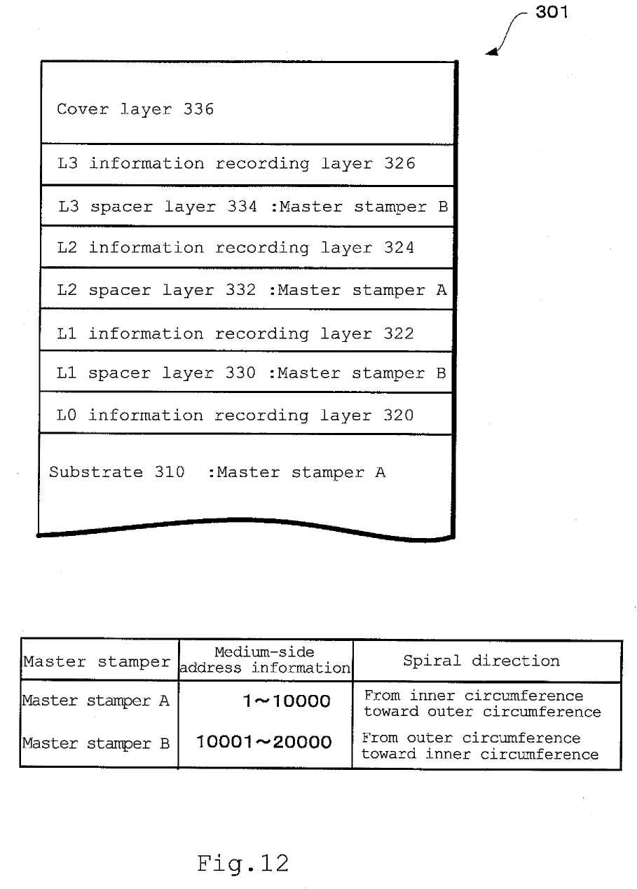

Now, with reference to FIG. 12, a description will be made to a multi-layered optical recording medium 301 according to a sixth embodiment of the present invention. Note that except the structure of a spacer layer described below, a multi-layered optical recording medium 31 according to this embodiment is configured in the same manner as the multi-layered optical recording medium 1 of the first embodiment. Thus, the components of the multi-layered optical recording medium 301 of the sixth embodiment will be indicated with the reference numbers of the same lowest and second lowest digits as those corresponding ones of the multi-layered optical recording medium 1 of the first embodiment, without illustrating or describing the components.

The multi-layered optical recording medium 301 is manufactured using the master stamper A and the master stamper B. The master stamper A has an allocation range of 1 to 10000 as the first medium-side address information, with the spiral of the groove directed from inside toward outside. The master stamper B has an allocation range of 10001 to 20000 as the second medium-side address information, with the spiral of the groove directed from outside to inside.

More specifically, a substrate 310 and an L2 spacer layer 332 are manufactured using a stamper prepared with the master stamper A. Consequently, an L0 information recording layer 320 and an L2 information recording layer 324 have an allocation range of 1 to 10000 as the medium-side address information, with the spiral direction being set from inside toward outside. On the other hand, an L1 spacer layer 330 and an L3 spacer layer 334 are manufactured using a stamper prepared with the master stamper B. Consequently, an L1 information recording layer 322 and an L3 information recording layer 326 have an allocation range of 10001 to 20000 as the medium-side address information, with the spiral direction being set from outside to inside.

Accordingly, the L0 information recording layer 320 and the L2 information recording layer 324 to be included in a first information recording layer group have in common the first medium-side address information provided by the master stamper A. The L1 information recording layer 322 and the L3 information recording layer 326 to be included in a second information recording layer group have in common the second medium-side address information provided by the master stamper B. Furthermore, the information recording layers of the first information recording layer group and the second information recording layer group are to be alternately stacked. Note that the optical recording and reading system 100 shown in the first embodiment can perform recording and reading operations on the multi-layered optical recording medium 301.

The multi-layered optical recording medium 301 according to the sixth embodiment has a four-layer structure. Nevertheless, the L0 information recording layer 320 and the L2 information recording layer 324 are provided with the same medium-side address information using the master stamper A. Additionally, the L1 information recording layer 322 and the L3 information recording layer 326 are provided with the same medium-side address information using the master stamper B. Accordingly, only the two types of master stampers A and B make it possible to manufacture the multi-layered optical recording medium, thereby significantly cutting the manufacturing costs. Furthermore, the number of types of stampers is reduced. It is thus possible to facilitate the management of the stampers and reduce the possibility of human errors such as use of wrong stampers in manufacturing.

Furthermore, the multi-layered optical recording medium 301 is configured such that the first information recording layer group (the L0 and L2 information recording layers 320 and 324) formed using a stamper prepared with the master stamper A and the second information recording layer group (the L1 and L3 information recording layers 322 and 326) formed using a stamper prepared with the master stamper B are alternately stacked. As a result, the distance between the information recording layers having the same medium-side address information can be increased, thereby reducing the possibility of confusing between both the layers during recording and reading. As described above in relation to the first embodiment, the layer position determination unit 111 checks the spiral direction or the allocation range of address for the difference in the medium-side address information before recording (reading). Thus, even when an information recording layer adjacent to the target information recording layer is erroneously focused, the first information recording layer group and the second information recording layer group can be distinguished, thus making it possible to detect and correct for the error in advance.

As described above, only such a case has been shown in the present embodiment in which the information recording layers of the multi-layered optical recording medium have a four-layer structure. However, the present invention is not limited thereto. It is also acceptable for the information recording layers to have an other-than-four-layer structure so long as the structure has two or more layers. Furthermore, only such an example has been shown in which the information recording layer is of the write-once type. However, the present invention is not limited thereto. It is also acceptable for the information recording layer to be of the rewritable type made of a phase-change material or of other information storage types.

Furthermore, in the present embodiment, only such a case has been shown in which at least two types of master stampers are used to manufacture the multi-layered optical recording medium. However, the present invention is not limited thereto. For example, the invention is also applicable to a case where all the information recording layers of the multi-layered optical recording medium are provided with the same address, so that one type of master stamper can be used to manufacture the multi-layered optical recording medium.

Furthermore, the distance from the light incident surface to each information recording layer or the material combination and the thickness of each information recording layer are not limited to these examples described above. For example, in the present embodiment, only such a case has been shown in which all the information recording layers are stacked within 110 μm from the light incident surface. However, the present invention is not limited thereto. To realize a multi-layered structure, some or all of the information recording layers may also be stacked outside the range of 110 μm.

Note that the method for optical recording and reading and the optical recording and reading system according to the present invention are not limited to the aforementioned embodiments, and may be modified in a variety of ways without departing from the scope and spirit of the present invention.

The present invention is widely applicable to recording and reading on various types of multi-layered optical recording media.

The entire disclosure of Japanese Patent Application No. 2007-308133 filed on Nov. 29, 2007 including specification, claims, drawings, and summary are incorporated herein by reference in its entirety.

What is claimed is:

1. A multi-layered optical recording medium having a plurality of information recording layers, wherein at least two layers of the information recording layers have same medium-side address information.

2. The multi-layered optical recording medium according to claim 1, wherein the at least two layers of the information recording layers having the same medium-side address information each are configured to have at least partially a determination area of mutually different optical reflection properties, to allow a layer position thereof to be identified.

3. The multi-layered optical recording medium according to claim 1, wherein the at least two layers of the information recording layers having the same medium-side address information each are provided with an identification signal recorded to identify the layer position.

4. The multi-layered optical recording medium according to claim 1, wherein the at least two layers of the information recording layers having the same medium-side address information are configured to have mutually different recording properties so that they can identify their layer positions from the recording properties.

5. The multi-layered optical recording medium according to claim 1, wherein the at least two layers of the information recording layers having the same medium-side address information are configured to have mutually different optical reflectivity settings, to allow their layer positions to be identified.

6. The multi-layered optical recording medium according to claim 1, wherein an information recording layer different in the medium-side address information from the at least two layers of the information recording layers is interposed between the at least two layers of the information recording layers having the same medium-side address information.

7. The multi-layered optical recording medium according to claim 1, comprising a first information recording layer group including the information recording layers having in common first medium-side address information and a second information recording layer group including the information recording layers having in common second medium-side address information different from the first medium-side address information, wherein the information recording layers of the first information recording layer group and the information recording layers of the second information recording layer group are alternately stacked.

8. A method for optical recording and reading, the method comprising:
irradiating a multi-layered optical recording medium with laser light, the multi-layered optical recording medium including at least two information recording layers having same medium-side address information; and
identifying a layer position of the information recording layer from a difference in optical reflection property between the information recording layers.

9. The method for optical recording and reading according to claim 8, comprising identifying the layer position of the information recording layer from a difference in stray light of reflected beams between the information recording layers when focused.

10. The method for optical recording and reading according to claim 8, comprising identifying the layer position of the information recording layer from a difference in reflectivity between the information recording layers when focused.

11. A method for optical recording and reading, comprising:
irradiating a multi-layered optical recording medium with laser light, the multi-layered optical recording medium including at least two information recording layers having same medium-side address information; and
identifying a layer position of the information recording layer based on how many times the information recording layers are traversed by the laser light in the direction of the stacked layers while the laser light is focused thereon.

12. A method for optical recording and reading, comprising:
irradiating a multi-layered optical recording medium with laser light, the multi-layered optical recording medium including at least two information recording layers having same medium-side address information; and
identifying a layer position of the information recording layer by reading an identification signal recorded on the information recording layer.

13. A method for optical recording and reading on a multi-layered optical recording medium including at least two information recording layers having same medium-side address information, the method comprising:
focusing the information recording layers of the multi-layered optical recording medium; and
identifying a layer position of the information recording layer from an amount of correction for spherical aberration.

14. A method for optical recording and reading on a multi-layered optical recording medium including, between at least two information recording layers having same medium-side address information, an information recording layer different in spiral direction from the two information recording layers, the method comprising:
irradiating the multi-layered optical recording medium with laser light;
detecting a spiral direction of the information recording layer from a tracking control value for an optical pickup; and
thereby identifying a layer position of the information recording layer.

15. A method for optical recording and reading on a multi-layered optical recording medium including at least two information recording layers having same medium-side address information, the method comprising:
irradiating the multi-layered optical recording medium with laser light; and
identifying a layer position of the information recording layer based on an information recording condition for the information recording layer.

16. A method for optical recording and reading on a multi-layered optical recording medium including at least two information recording layers having same medium-side address information, wherein,
when irradiating the multi-layered optical recording medium with laser light to record information thereon, a medium-side address at which a recording signal is written is made different from an information-side address which the recording signal has.
